(19) United States
(12) Patent Application Publication
(10) Pub. No.: US 2007/0038821 A1
(43) Pub. Date: Feb. 15, 2007

(54) Hard drive with integrated micro drive file backup

(76) Inventor: Phillip Alexander Peay, Cary, NC (US)

Correspondence Address: RUDOLPH J. BUCHEL JR., LAW OFFICE OF, P. O. BOX 702526, DALLAS, TX, 75370-2526, US

(21) Appl. No.: 11/200,367

(22) Filed: Aug. 9, 2005

(51) Int. Cl. G06F 12/00

(52) U.S. Cl. 711/162

(57) ABSTRACT

The present invention is directed to backing up temporal information in a primary storage memory of a computer system. A temporal backup memory is provided as being physically separate from a primary hard drive of the computer system, and removable coupled to a primary drive assembly with the primary hard drive. Data is designated for temporal backup by data parameters, such as file name, type, or resident directory name. A temporal time period is specified as the time between successive temporal backups. At the end of each temporal time period, the primary hard drive is scanned for data designed for temporal backup and that has been temporally modified, i.e., modified since the last successful backup. The data on the hard drive designated for temporal backup is compared with archival data so as not to duplicate archived data in the temporal backup memory. Free memory space in the temporal memory is tracked. When free memory space becomes low, the temporal data is archived and deleted to make room for newer data in the temporal backup memory. Alternatively, if the data exists simultaneously in both the temporal backup memory and the archival memory, that data can be safely removed from the temporal memory to free up space.

### BACKGROUND OF THE INVENTION

The present invention relates to data backup. More particularly, the present invention relates to automatically backing up data between archival backups.

The primary computer storage device for storing electronic information, files, programs, system parameters or databases is the hard disk drive, or more simply referred to as a hard drive. A hard drive is the data center for a PC or laptop with all of the programs and data stored between the occasions that the computer is in use. The hard drive is the most important of the various types of permanent storage used in a PC environment (the others being floppy disks and other storage media such as CD-ROMs, tapes, removable drives and flash memories, etc.). A hard drive is usually faster and more permanent than other storage computer media.

A hard drive can be described generally as an electromechanical device comprising one or more fixed high-capacity rigid disk, or platters, made of aluminum or glass for storing the data. Data are read from or written onto the platters by means of a series of electromagnetic read/write heads that contact the surface of the platters while the platter are rotated or spun on a spindle by an electric motor. Hard drives are the preferred storage medium in desktop and laptop computers as well as servers and mainframes for storing short to intermediate-term data for subsequent retrieval. However, as with any device which utilizes both mechanical and logical service components, these also serve as sources for hard drive failure.

A logical failure usually results from a file-system corruption. These failures typically result from viral infection, accidental deletion of key files (such as the master boot record) or registry components, failure of a logical component or even electro-static discharge. In many cases, after a logical failure the drive may still be recognized by the system BIOS, but may not boot properly. In some cases, the information resident on the hard drive may still be intact, but inaccessible due to the logical failure.

The other type of failure is a hard or physical failure in which a physical component fails. The two primary types of physical hard drive failures are mechanical and electronic. Mechanical failures usually result from malfunctions of the spindle motor or electromagnetic read/write heads. Typically, these problems develop over time and can often be detected before a catastrophic failure of the drive occurs. Electronic failures are far less predictable and may occur unexpectedly at any time. Even new hard drives are not totally immune to electrical failures.

One metric for assessing the importance of hardware component is the amount of hardship caused by its failure. Because the hard drive is the data center for the computer owner's entire corpus of electronic data, the loss of a hard drive can be disastrous for the user or a business relying on the stored information. When the standard measurement for determining the importance of a hardware component is the time to recreate the stored information, a hard disk is, by far, the most important component of a typical PC. IT professionals understand that hardware is easily replaced, but data is not.

Backup, sometimes referred to as archiving or archival backup, is the act of copying electronic information, files, programs, system parameters or databases so that they will be preserved in case of equipment failure or other catastrophic events. Backup is usually a routine part of the operation of large businesses with servers as well as the administrators of smaller business computers. IT professionals often categorize data as two types: that which has already been archived by backup and that which has not yet been lost. For personal computer users, backup is also necessary, but often neglected.

Ideally, the system partition and newly created and/or modified data files should be backed up daily. For a stand alone computer, backups may be accomplished on a second local hard drive, tape drive, CDs or DVDs. Hard drive backups are usually less troublesome than either tape, CD or DVD backups. Network computers are often automatically backed up to a mirror server daily, or at least several times a week. Typically, the backups are scheduled during periods of low network usage, such as late nights and early mornings, in order to avoid congesting the network with backup data. However, if the network traffic is above a predetermined threshold level or a computer is unavailable to be backed up, the process skips the backup session, or at least until the network traffic subsides and the computer becomes available to the network backup utility.

For many users there are two issues with current backup options: complexity and size. Many users are confused and intimidated by the setup required to simply backup the data they have on their computers. The idea of purchasing a new computer, installing a second hard drive, or partitioning a secondary drive to backup data is simply beyond their technical grasp or their financial budget for computing. The alternative is to use CD's, DVD's or other removable devices to store data. If a user relies on imaging programs, backing up the data can take many CD's and an extraordinary amount of time. If the user manually backs up data from the hard drive by simply selecting important files for copying, meticulous records should be kept to ensure that there are no files left behind. Furthermore, even if the user's records are well kept, any temporal information, i.e., information written to the hard drive between backups, will be lost and must be recreated.

### BRIEF SUMMARY OF THE INVENTION

According to one aspect of the present invention, a method for backing up temporal data in a computer system comprises receiving a data property in which the data property designates data stored in a primary memory of the computer system for temporal backup, receiving a temporal backup time period in which the temporal backup time period defines a minimum time between successive temporal backups, identifying a temporal backup memory for storing temporal data in which the temporal backup memory is physically separate from the primary memory of the computer system and removably coupled to a primary drive assembly with the primary memory and performing a temporal back up. The temporal backup may comprise detecting a time interval equivalent to the temporal backup time period, identifying data in the primary memory with the data property, and copying the identified data to the temporal backup memory.

### BRIEF DESCRIPTION OF THE SEVERAL VIEWS OF THE DRAWINGS

FIGS. 1A and 1B are orthogonal views of a hard drive with an integrated mass storage file backup in accordance with an exemplary embodiment of the present invention;

FIG. 2 is a diagram of a flowchart depicting a process for designating information on a primary drive of a computer for temporal backup on a temporal backup device in accordance with an exemplary embodiment of the present invention;

FIG. 3 is a diagram of a flowchart depicting a high level process for temporally backing up data from a primary drive of a computer to a temporal backup device in accordance with an exemplary embodiment of the present invention;

FIGS. 4A and 4B are diagrams of a flowchart depicting a lower level process for temporally backing up data from a primary drive of a computer to a temporal backup device in accordance with another exemplary embodiment of the present invention;

FIG. 5 is a flowchart depicting a hierarchical process for freeing temporal memory space in response to receiving a memory warning in accordance with an exemplary embodiment of the present invention; and

FIG. 6 is a flowchart depicting a process for restoring a faulty drive using hard drive with an integrated mass storage file backup in accordance with an exemplary embodiment of the present invention.

Other features of the present invention will be apparent from the accompanying drawings and from the following detailed description.

### DETAILED DESCRIPTION OF THE INVENTION

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects all generally referred to herein as a “circuit” or “module.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java7, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

The present invention is not limited by the type of data interface used for connecting the hard drive to a system bus. The more common disk interfaces are, ST412/506, SCSI-(I&2) (Small Computer System Interface), IDE (Integrated or Intelligent Drive Electronics) and EIDE (Enhanced IDE), ESDI (Enhanced Small Device Interface), ATA (AT Attachment), SATA (Serial ATA) and SATA II.

Still further, the present invention may utilize any conventional type of removable mass storage device in a wide variety of form factors, the more common of which are: Secure Digital (SD), CompactFlash (CF) Types I and II (a trademark of and available from Sandisk Corporation (Sandisk) of Delaware, USA), SmartMedia (SM) (a trademark of and available from Kabushiki Kaisha Toshiba DBA Toshiba Corporation (Toshiba) of Japan), Memory Stick (MS) (a registered trademark of and available from the Sony Corporation (Sony) of Japan), MultiMediaCard (MMC), xD-Picture Card (xD) (a trademark of and available from Fuji Photo Film Co., Ltd. (Fujifilm) of Japan) and Microdrive (a registered trademark of and available from Hitachi Global Storage Technologies Netherlands).

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Normally, most computer users create word processing documents, spreadsheets, and presentations that are important and valuable to them and then store those files on the primary drive of their computer. These files are periodically backed up to another storage device for safety. Other larger files, e.g., image and music files are normally saved to an optical disk or other removable device and available thereafter, for instance, to share with others. While it would be advantageous to have a complete backup of the system, all files created and/or file modifications between system backups are lost subsequent to a drive failure. Ironically, these are the files that are the least expensive to backup, but are usually lost due to an inopportune system backup scheduling. In accordance with one embodiment of the present invention, newly created or modified files resident on a primary drive are temporally mirrored on a temporal backup between system backups. For the purposes of describing the present invention, the term “archival backup” refers to a conventional system backup process in which files and/or directories are backed up from the system's primary storage drive to another storage medium, for example, to a network mirror drive or the like. Archival backup may be automated process that executes autonomously on a predetermined date and/or time. Alternatively, an archival backup may be a manual process that is undertaken by the user copying selected directories or files to a separate storage device, such as a secondary local drive or an optical storage medium, e.g., a CD or DVD. The term “temporal backup” refers to the process of backing up data temporally with its creation or modification.

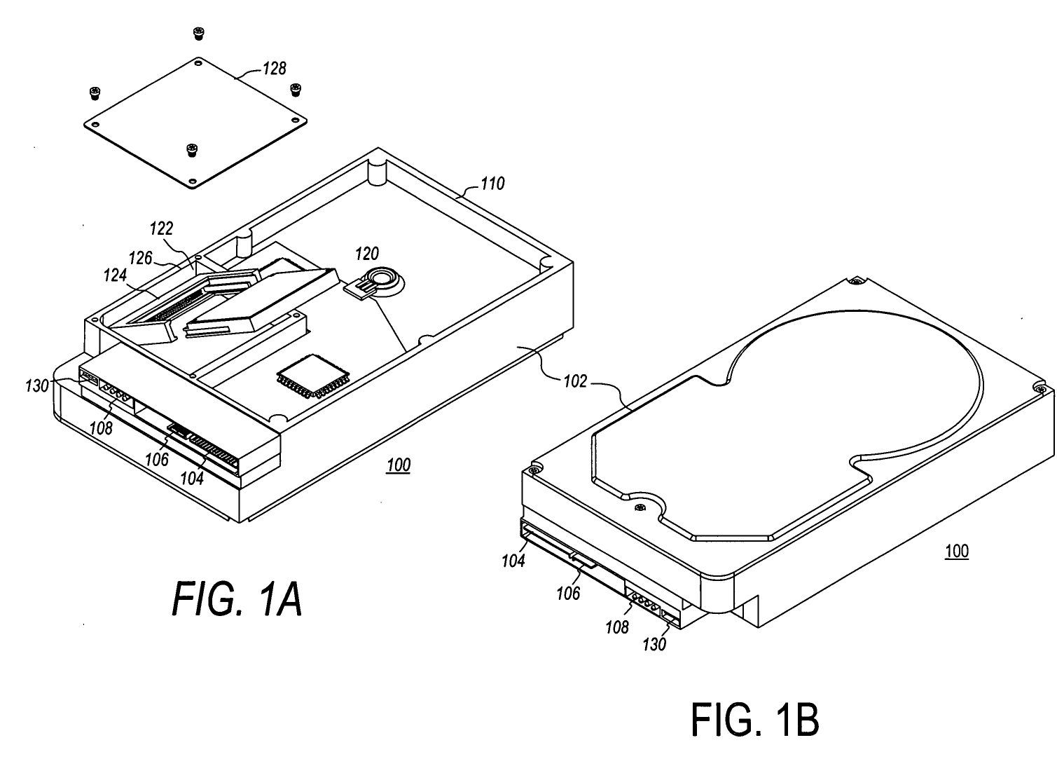

FIGS. 1A and 1B are orthogonal views of a hard drive with an integrated mass storage file backup device in accordance with an exemplary embodiment of the present invention. FIG. 1A is a lower view of hard drive assembly 100 while FIG. 1B is an upper view of the drive. Hard drive 100 generally comprises primary hard drive 102, for storing data and the like generated on a data processing system, and also mass storage file backup 122 for performing temporal backups of data files from primary drive 102. Primary drive 102 comprises internal components of one or more platters mounted on a spindle and mechanically coupled to a spindle motor for rotating or spinning the platter(s) adjacent to a series of electromagnetic read/write heads. Data are transmitted to and from primary drive 102 across SATA-type data connection 104, while power is provided to the drive either at SATA power connection 106 or legacy Ultra/ATA133/EIDE/IDE power connection 108.

Hard drive assembly 100 differs from prior art hard drives in that it comprises both primary drive 102 and mass storage file backup 122 (referred to below as temporal backup 122). Mass storage file backup 122 includes removable mass storage device or memory 120, reader/writer electronics 124, data connection 130 and perhaps a separate power connection (not shown). Storage compartment 126 and cover 128 are configured in frame 110 to house memory 120 and at least a portion of reader/writer electronics 124. Temporal backup device 122 is used for temporally backing up copies of only designated files that have been recently created or modified, as opposed to typical archival backup devices that store copies of all files at regular time intervals.

Backup data is readily available to the user for restoring the system, in the event of a drive failure, from removable memory 120. The memory can easily be removed from storage compartment 126 using a screw- or star-driver to detach cover 128. However, because removable memory 120 is out of the user's sight and immediate presence, and because it is slightly more difficult to remove the memory, the user is not tempted to use removable memory 120 for anything other than a temporal backup.

As depicted in the exemplary embodiment, temporal backup device 122 receives and transmits data over data connection 130, which couples temporal backup device 122 to a system bus, or to a controller on a system bus. With particular regard to FIG. 1, memory 120 is depicted as a miniature hard disk drive device, as a CompactFlash device with a type II form factor. It should be understood that this depiction is merely an example for ease in understanding the operation of the present invention and is not intended to limit the scope of the invention. Flash cards or types of removable storage media may also be used without departing from the scope and spirit of the present invention. Optionally, reader/writer electronics 124 may take the form of a multi-card for accepting various types of removable memory media configured in a variety of form factors. In that case, memory 120 may take the form of any type of memory device that is compliant with reader/writer electronics 124.

As depicted in the figure, data connection 130 and reader/writer electronics 124 are shown as USB-type devices (Universal Serial Bus), or more specifically, USB 2.0 or Hi-Speed USB interface devices for transferring data between an internal USB controller/adapter on a system bus and data connection 130. The USB standard has been almost universally adopted by the computer industry. Contemporary computer systems provide ample support for simultaneously connecting multiple USB devices and most provide internal support for USB devices to a USB controller coupled to the system bus. However, temporal backup 122 may also operate on other types of interfaces, for instance IDE (actually an AT Attachment or ATA interface) or SATA (serial ATA).

A local system may be configured with two separate drives: a primary drive, and a secondary drive. Files from the primary drive may be archived to the secondary drive on predetermined backup dates. However, many types of interface adapters support only a limited number of devices under a “Master” and “Slave” paradigm. For instance, the IDE adapter generally supports only two drives and most data connections are preconfigured with one master and one slave connection. The SATA-type interface supports eight or sixteen drives, and typically, a system's mother board is ported with four, six or eight independent SATA data connections. Thus, configuring reader/writer electronics 124 as a SATA-type interface device enables temporal backup 122, primary drive 102 and other SATA drives to be simultaneously coupled directly to the system bus for transferring data to and from each other via the bus.

While USB may be the most flexible and universally accepted of all common interfaces, most system's BIOS do not support USB memory devices on the memory boot list and, therefore, will not boot the system from a USB memory device. BIOS support for system booting from controller integrated devices, such as IDE and SATA memory devices, is extremely common. Thus, if configured as a BIOS supported interface device, temporal backup 122 will be recognized by the BIOS, thus enabling the system to be booted directly from the temporal backup device. Additionally, the configuration and startup files stored in temporal backup 122 may be more comprehensive than those typically associated with a standard rescue boot disk, such as CONFIG.SYS and AUTOEXEC.BAT files. Booting from temporal backup 122 is generally less complicated than booting from a standard boot disk, and in reality, rescue boot disks may be dispensed with altogether since temporal backup 122 contains a much more current boot image of the system. Moreover, since memory 120 is removable, it can be inserted into the reader of a replacement hard drive assembly, having a formatted replacement primary drive, for the initial boot up. The replacement primary drive can then be restored with files from the archive backup, and the restoration supplemented with the temporal backup files from memory 120. Even if a boot disk is ultimately necessary for booting a system, the boot image from the temporal backup will be much more current than a standard rescue boot disk, usually created months in advance, and may also include system and boot files that are usually not found on a standard rescue boot disk.

Configuring primary drive 102 and temporal backup 122 as IDE devices enables system booting from temporal backup 122. However, because the IDE interface adapter generally supports a maximum of two like drives, no other IDE drives can be connected to the system bus for archival backup of primary drive 102. If the system is configured with a primary and secondary IDE hard drives, the IDE adapter will not support an IDE type temporal backup device. A USB type temporal backup device may be used instead. Even if the system cannot be booted directly from the temporal backup drive, a boot disk may be created from the up-to-date system configuration and startup files backed up to temporal backup 122.

Also presented herein is a temporal backup process and software program product for efficiently and temporally backing up important files from primary drive 102 to temporal backup 122 that are modified between archival system backups in accordance with an exemplary embodiment of the present invention. These important files are typically lost in the event of a prior art drive failure. Certain types of information on the primary drive is automatically backed up to the temporal backup device (default temporal backup files), while other information may be designated by a user for temporal backup (user designated temporal backup files). For instance, system information, system configuration parameters, startup and initialization files and boot records are automatically backed up to the temporal backup device at system startup, shut down or both. Also, certain files, file types and/or directories may be pre-designated as default temporal backup files. These types of files may include the auto-recovery and temporary files that are automatically saved by the system between user initiated saves. The default backup files may be deselected by the user. Other system and data files may be designated by the user for temporal backup based on file parameter values.

Generally, system information may be user-designated for temporal backup in several different ways. One way is to merely store all important files in a named directory on the primary drive, such as c:/myfiles/documents. That directory is designated by the user for temporal backup and overwritten on the temporal backup device at predetermined time intervals. Any changes saved to the user-designated directory are reflected by the copy stored in the temporal backup device. Alternatively, the application may scan the user-designated directory at predetermined intervals for only the files modified since the last system backup and after the latest temporal backup. Only those files are copied into the temporal backup device. In accordance with still another exemplary embodiment of present invention, the process secures an archived file list from the archive process and compares any files to be temporally backed up to the archival file. Only files not on the archival list are backed up since copies of files already reside in the archival backup memory.

Another way for a user to designate information for temporal backup is by the user defining specific file parameter value. One file parameter for designating temporal backup is the file type (e.g., .doc, xis, .txt, .pdf). Care should be exercised when designating Internet and email files for temporal backup as voluminous nature of these files may fill the temporal memory in a relatively short time period. Alternatively, files may be designated for temporal backup by file parameters of the author's username or by some combination of the type and author name, i.e., designating a specific file type for temporal backup if authored by a specific user. In contrast, some files or directories may be user-designated as to be ignored and not backed up. These files may also be designated by the file type or author, or by a combination of the two, i.e., designating a file type for temporal backup, but ignoring the file if authored by a specific user.

The temporal backup process executes in the background and performs backups at predetermined time intervals based, for example, on the availability of current on system resources, e.g., CPU usage, memory usage, page memory usage, etc. At predetermined time intervals, the application checks the system resource levels and if they are determined to be below a threshold level, the temporal backup of designated files proceeds. If not, the temporal backup process is postponed and the system resource levels are rechecked at a later time. When resources are available, the application scans the directories of the primary drive for designated files that were modified (or created) subsequent to the last system backup and after the most recent temporal backup. The files identified for backup during the scan are copied to the temporal backup device. Duplicate files, such as a file stored in two different folders on the primary drive, are not backed up in duplicate on the temporal backup device in order to conserve memory space. Additionally, the process tracks the available space on temporal backup device and alerts the user if the memory is low.

As may be apparent, the present invention provides an average computer user with a safety net for backing up data in general, and for temporally created data in particular, that is less expensive then implementing a full backup process, is less complicated to use than the current backup software available in the consumer market, and less time consuming then manual backups to optical memory media.

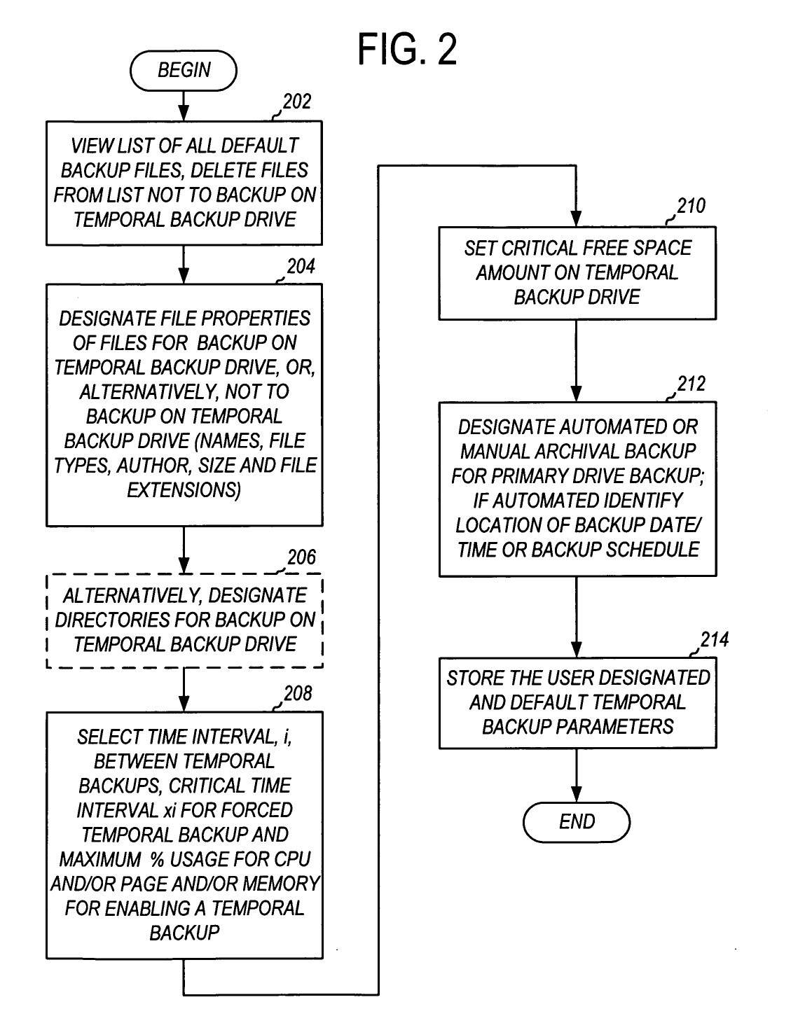

FIG. 2 is a diagram of a flowchart depicting a process for designating information on a primary drive of a computer for temporal backup on a temporal backup device in accordance with an exemplary embodiment of the present invention. The process begins with the user viewing a list of all default temporal backup files (those pre-selected to be temporally backed up) (step 202). The user may deselect any files that have been pre-selected as default backup files in the temporal backup application. Next, the user designates all files to be backed up on the temporal backup device (or ignored for backup) by file properties, for instance, file name, file extension, author, size, etc., or by combinations of file properties (step 204). Alternatively, or in addition, the user may merely designate one or more directories to be backed up on the temporal backup device (step 206).

Table I below is a file table created by the temporal backup application for identifying all files to be temporally backed up to the temporal backup device. Notice in the first row of the table that the user has designated all files in the directory “C:\my document” to be temporally backed up on the temporal backup device without exception. However, the user may use a more fine grained approach for specifying temporal files for backup. For example, from the fourth row, it can be appreciated that the user designated only files in directory C:\my files with .doc extension and the word “patent” in the file name, that are less than 2 MB and not authored by user jbrown for temporal backup. However, only those designated files that were modified (or created) after the latest temporal backup will be backed up to the temporal backup device. The fifth row lists default files to be temporally backed up. For example, the directories listed in the fifth row correspond to recovery, backup and temporary files that are automatically saved by the respective applications operating on the system, between user initiated save operations. System startup and boot files that are designated for backup are listed in the sixth row.

TABLE I

| | | | file | | |
|---|---|---|---|---|---|
| owner | dir | file name | type | author | size |
| user | +C:\my document | | | | |
| user | | | +.doc; | | |
| | | | +.xls; | | |
| | | | +.pdf | | |
| user | | | | −jdoe; | |
| | | | | +janedoe | |
| user | +C:\my files | +patent | +.doc; | −jbrown | +<2 mb |
| default | +C:\Documents and | | | | |
| | Settings\janedoe\Application | | | | |
| | Data\Microsoft\Word; +C:\Documents | | | | |
| | and Settings\janedoe\Application | | | | |
| | Data\Microsoft\Excel; | | | | |
| | +C:\Documents and | | | | |
| | Settings\janedoe\Application | | | | |
| | Data\Microsoft\PowerPoint; | | | | |
| | +C:\Documents and | | | | |
| | Settings\janedoe\Application | | | | |
| | Data\Microsoft\Office\Recent | | | | |
| default | | +Boot.ini; +Ntoskrnl.exe; | | | |
| | | +Bootvid.dll; +Hal.dll; | | | |
| | | +Ntdetect.com; | | | |
| | | +Pagefile.sys; | | | |
| | | +Ntbootdd.sys; | | | |
| | | +Ntoskml.exe; | | | |
| | | +Ntkrnlpa.exe; +Hal.dll; | | | |
| | | Win32k.sys; +Ntdll.dll; | | | |
| | | +Kernel32.dll; | | | |
| | | +Advapi32.dll; | | | |
| | | +User32.dll; +Gdi32.dll | | | |

Next, the user selects an appropriate backup time interval, “i”, in which to attempt successive temporal backups (step 208). For example, if the user selects i=4.0 hours, the temporal backup process will attempt to make a backup every four hours, or two backups every work shift. By selecting the relatively long time interval, a large amount of data may be lost in the event of a drive failure (up to four hours worth of modified file information). Therefore, a more conservative time interval, i, may be selected, for example 10 to 20 minutes, to ensure that only a minimal amount of important data, modified after the last temporal backup, is lost as a consequence of a drive failure.

Optionally, the user may also select a critical backup time interval, “X”, for forcing temporal backup. This time may be a multiple of the backup time interval. For instance, “xi”, for forcing a temporal backup after x-number of i length time intervals without a successful temporal backup. Optimally, the temporal backup process is executed in the background as to not interfere with applications executing in the foreground. To ensure that the temporal backup process does not impede the performance of other applications executing on the system, the user may also select thresholds for the maximum usage level of certain system recourses in allowing a normal temporal backup. For example, threshold levels for system resources of CPU, page and/or RAM usage may be designated by the user. However, under certain circumstances the system usage might not drop below the maximum usage threshold for enabling a temporal backup. In that case, the temporal backup process will postpone a backup for up to x number of i length time intervals before a forced temporal backup is invoked.

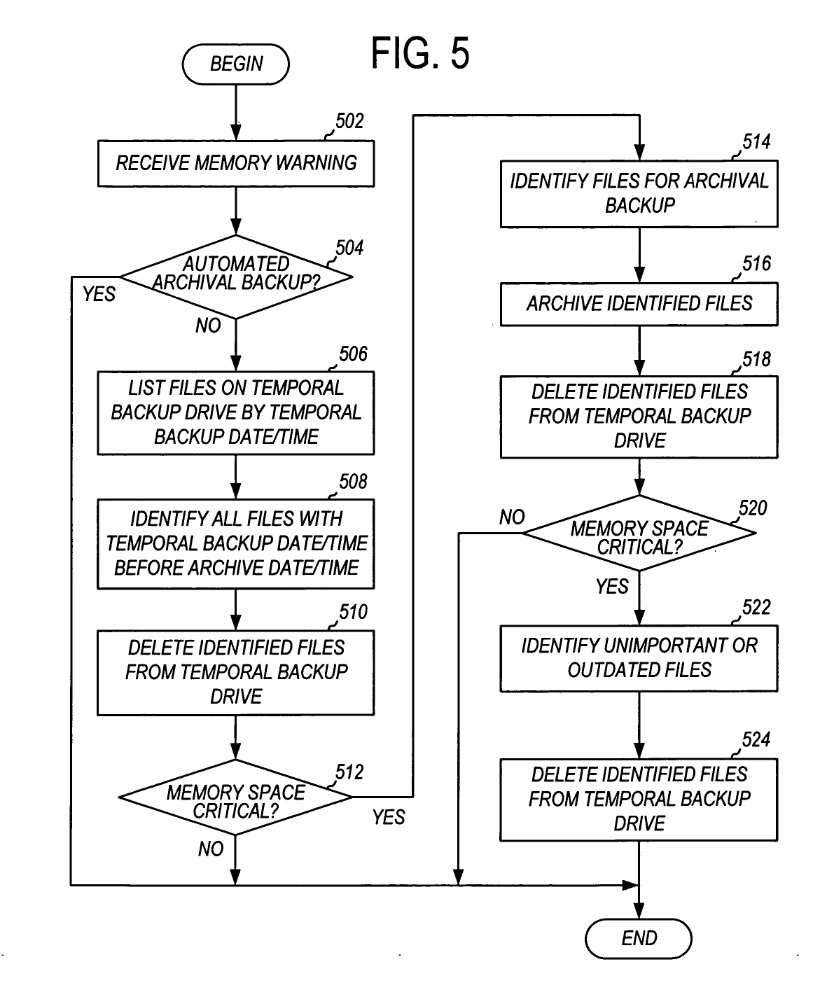

The user may specify an amount of free space (or percentage of total temporal memory space) (step 210). If the amount of free memory in the temporal backup device drops below the specified amount, the process generates a temporal memory space warning. A hierarchical process for freeing temporal memory space in response to receiving a memory warning will be discussed below with regard to the flowchart depicted in FIG. 5. The user may also designate whether the archival backup is automated or manual. If the archival backup process is automated, the user specifies a memory address for the date/time of the last successful archival backup (step 212). The temporal backup will access that address for the date/time of the last archival backup and delete any files stored in the temporal memory prior to that date/time. Alternatively, the user may merely enter the data of the last manual archival backup (or automated and the address is unknown). Finally, the user-defined temporal backup parameters are stored with the default temporal backup parameters (step 214) and the process then ends.

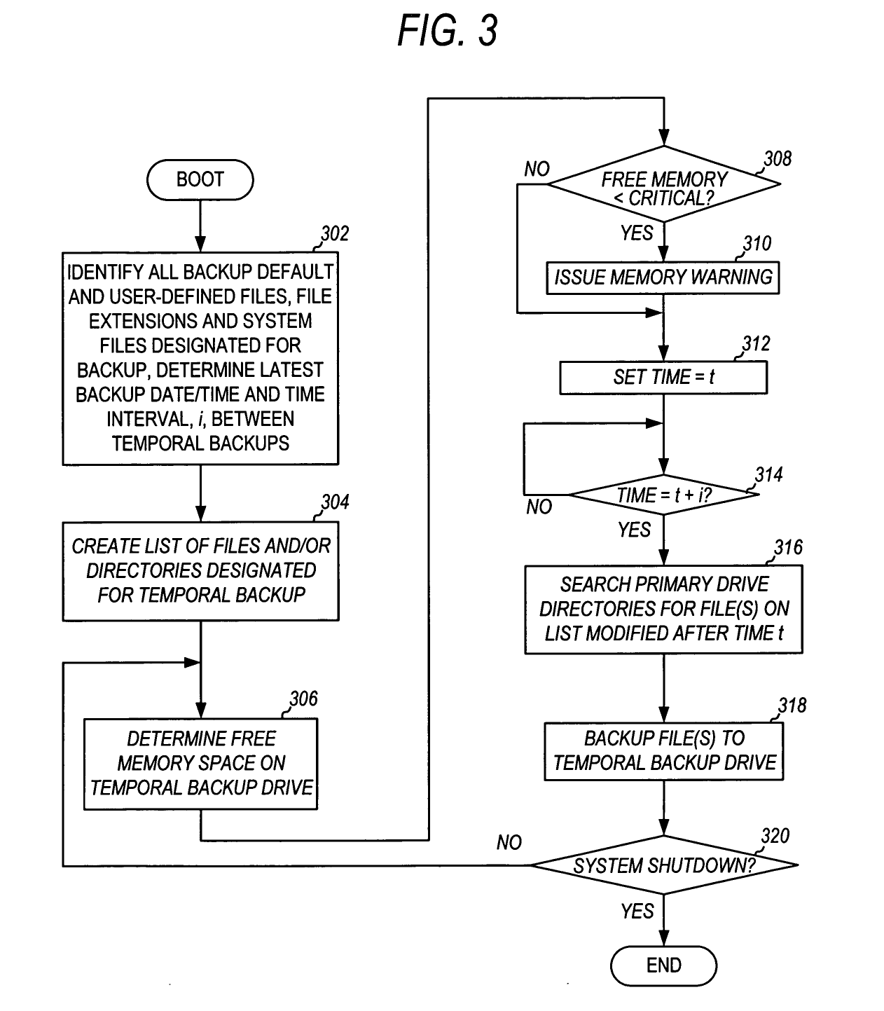

FIG. 3 is a diagram of a flowchart depicting a high level process for temporally backing up data from a primary drive of a computer to a temporal backup device in accordance with an exemplary embodiment of the present invention. It is expected that the temporal backup application is loaded automatically at system boot up and executes in the background thereafter. Therefore, initially, the temporal backup process identifies all backup parameter values designated in the process discussed immediately above (step 302). If not already in a tabular listing, the process creates a listing of all files and directories to be temporally backed up and the conditions for executing a temporal backup (step 304). The amount of free memory in the temporal backup device is then determined (either logically or from a memory usage table) (step 306), and tested against the user-defined memory parameter indicating a critically low memory condition (step 308). If the free temporal memory is critically low, the process displays a memory warning to the user (step 310). If the temporal memory space is not critically low, or if a warning has already been issued, the process proceeds by (re)setting an incremental time variable, t, (step 312) and iteratively testing for the occurrence of the backup time interval, i.e., the time condition TIME=(t+i) (step 314). When the temporal backup time interval is detected, the process scans the primary drive for files on the temporal backup list that were modified after TIME=t (time of the last temporal backup) (step 316) and backs up those files to the temporal backup device (step 318). The process repeatedly iterates to step 306 for determining the amount of free memory space after writing to the temporal backup device, checks for critical memory space, monitors time and scans the primary drive for files which are successively backed up to the temporal backup drive (steps 308 to 318) until system shut down (step 320) at which time the process ends.

As may be appreciated, the process described may be performed in association with any temporal backup device, whether or not the temporal backup device and primary hard drive are like-interface types, or coexist in common assembly. As mentioned above, the temporal backup memory may be any memory media and reader/writer electronics may support and type of interface.

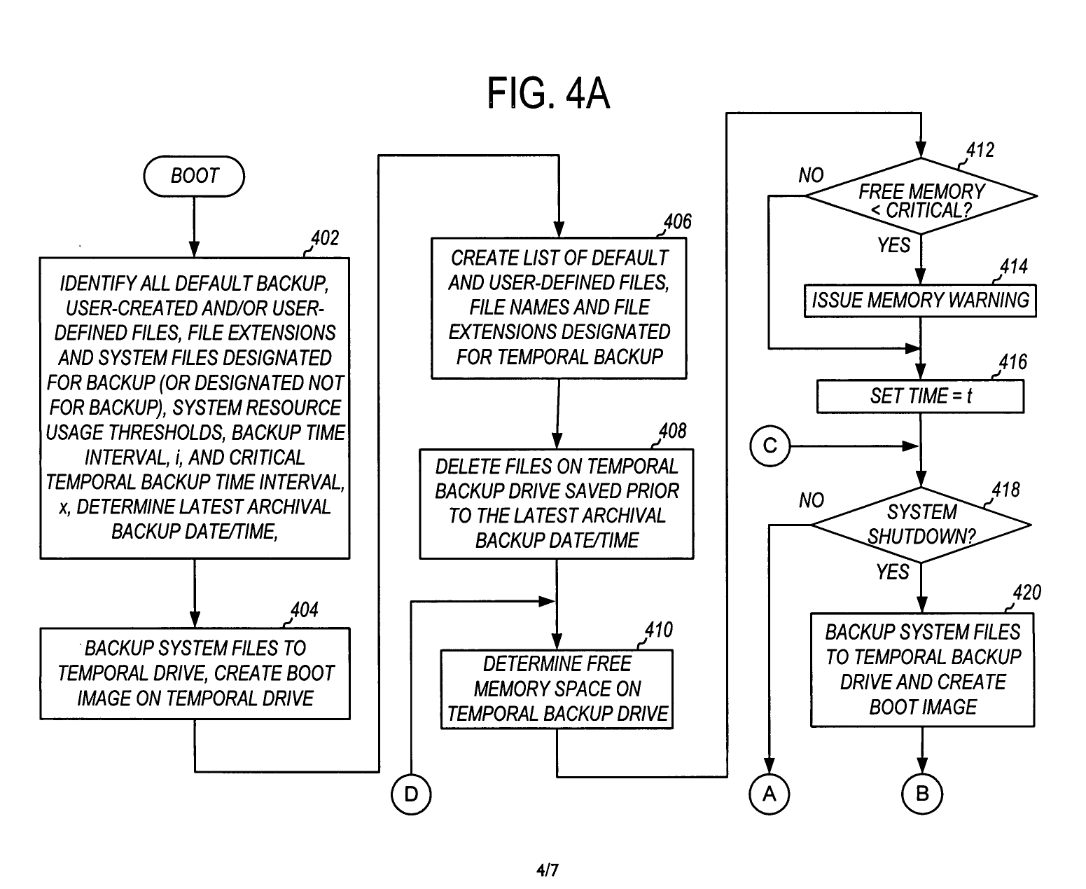

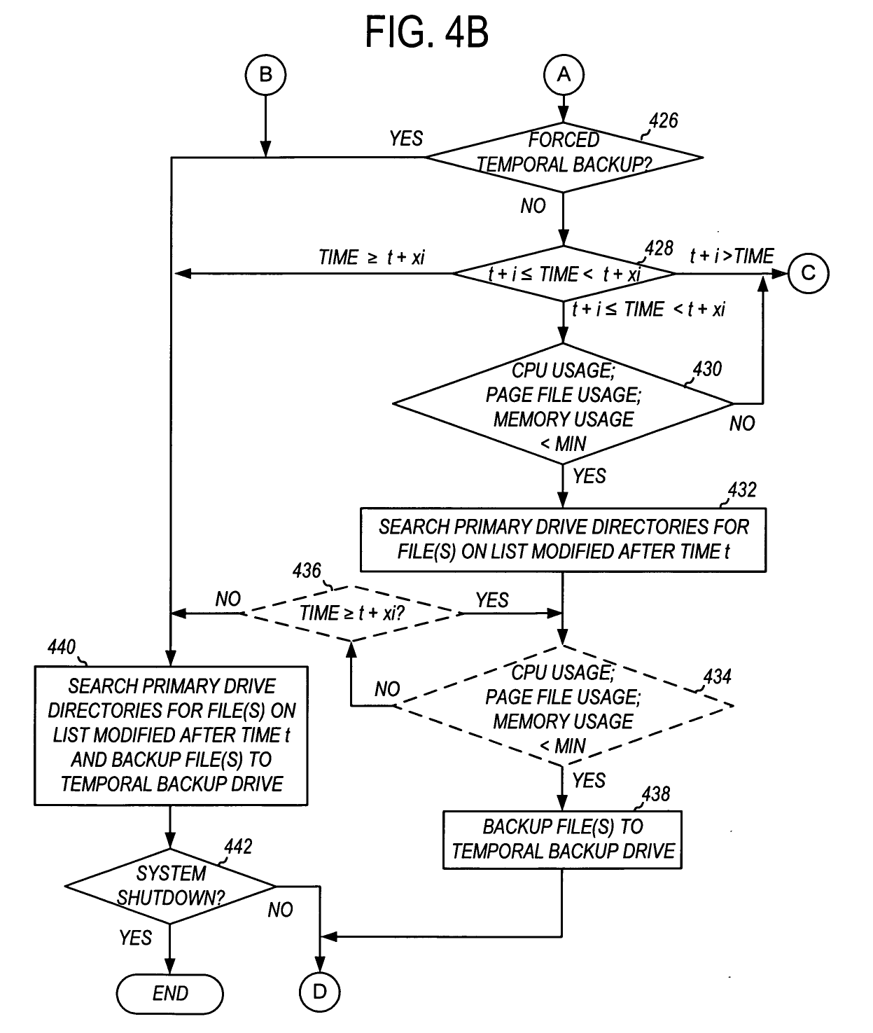

FIGS. 4A and 4B are diagrams of a flowchart depicting a lower level process for temporally backing up data from a primary drive of a computer to a temporal backup device in accordance with another exemplary embodiment of the present invention. The present temporal back up process is more automated than the process discussed above and cooperates with a resident archival backup process by backing up temporally backed up files modified and created between successful archival backups. In some regards, the process depicted in FIGS. 4A and 4B is similar to the process shown in FIG. 3, therefore only the differences will be discussed in great detail. The temporal backup process begins at system boot-up by identifying all backup parameter values discussed above, but also including other parameters necessary for executing a more automated backup, such as the address for the date/time of the archival, system resources usage thresholds and a critical backup time interval (or multiple) (step 402). Then, immediately after boot the boot.ini and other startup files are copied to the temporal backup drive (step 404). In so doing, if the operating system recognizes new hardware, changes in RAM, etc, the boot image on the temporal backup device accurately reflects those system changes. If necessary, the process creates a listing of all files and directories to be temporally backed up and the conditions for executing a temporal backup (step 406). Next, using the archival backup date and time, the temporal backup process automatically deletes all files on the temporal backup device that conflict with the backup parameters, i.e., outdated or stale files which have been archived since being temporally backed up (step 408).

With the temporal backup drive cleaned of stale files, the process begins a series of iterative loops for determining when to identify which temporally modified files to backup and then backs up the identified files. At the start of the process, the amount of free memory on the temporal backup device is ascertained (step 410) and that amount tested for a critically low condition (step 412). A memory warning is issued to the user if the free memory is too low (step 414) and the incremental time variable is (re)set (step 416).

Next, the process determines whether or not to proceed into the iterative time loop depending on whether or not the system is in shutdown mode (step 418). If the system is being shutdown, the process circumvents the iterative time loop and immediately writes the system, startup and boot files to the temporal backup device (step 420) and forces a temporal backup by immediately searching the primary drive for all user designated and default files modified after the last temporal backup and backing up those files to the temporal backup drive (step 440). Once the forced temporal backup has been completed, the shutdown condition is verified (step 442) and the process ends (step 442). If the system is not in shutdown condition, once again the process determines free memory (step 410), tests the free memory amount for a critically low condition (step 412), and returns to iterative process for determining when to identify which temporally modified files to backup and backing up the identified files beginning at step 416.

The purpose of the time loop is to ensure that a temporal backup is performed in the most efficient manner possible given the current system usage conditions. After a predetermined time period has elapsed, the temporal backup proceeds only if the system usage is below a threshold level. If the current system usage is too high, the backup is postponed and the temporal backup process continues to monitor time and the system usage parameters. If the usage parameters drop below the threshold level, the temporal backup proceeds unabated. However, if the system usage remains higher than the threshold level, the temporal backup will not be postponed indefinitely. After a critical time period has elapsed, the process forces a temporal backup, and continues.

Returning to step 418, if the system is not being shut down, the process proceeds down the iterative time loop (shown in FIG. 4B). It is expected that the user will have the option to manually force a temporal backup for situations where the user suspects that the system is on the verge of a crash. Therefore, at each time iteration the system checks for a forced temporal backup command from the user (step 426), and if received, immediately identifies for all user designated and default files on the primary drive that have been modified after the last temporal backup and backs up those files to the temporal backup drive (step 440). If, at step 426, a forced backup command has not been received, the process continues monitoring the current time (step 428). Here, the time, as measured from the last temporal backup, is repeatedly checked for agreement with temporal backup time (TIME≧t+i) and simultaneously for agreement with a critical time (TIME≧t+xi). When (t+xi)>TIME>(t+i), the system resource usage is checked prior to performing a temporal backup. However, if the time since the last temporal backup is equal to critical temporal backup time; i.e., TIME≧(t+xi), a the regular temporal backup process is terminated and forced temporal backup is invoked. If neither condition is TRUE, i.e., (t+I)>TIME, the process iterates back through step 418 until either the system is shut down, or (t+xi) ≧TIME≧(t+i) (step 428).

If, at step 428, (t+I)≦TIME<(t+xi), a temporal backup will be invoked, but only if the system usage will accommodate the backup. The CPU, and/or page memory, and/or memory usage are checked against the pre-set threshold levels (step 430). Here it should be understood that performing a temporal backup with the system usage parameters above the threshold amount will temporarily impede the performance processes currently executing on the system, but not permanently hamper the operation of the system. However, continued diminished system performance, due to successive temporal backups, has the undesirable consequence of users disabling the temporal backup process to regain the lost system performance. Therefore, if possible, temporal backups are performed only when the system usage is below a threshold level which would be detectable by the user. Conversely, it should also be recognized that temporal backups should be performed regularly during periods of intense user activity (corresponding to periods of higher system usage) in order to save any important files that have been recently modified.

If, at step 430, the system usage parameters are below the threshold level, the primary drive is searched for files on the temporal backup list that were modified after the most recent temporal backup (step 432). Any files identified in the sweep may be immediately backed up to the temporal backup device (step 438), or altematively, the process may again check the system usage levels prior to writing to the temporal backup device (step 434). If the system usage remains below the threshold level, the identified files are backed up to the temporal backup device (step 438). If, at step 430, the system usage is above the threshold level, the temporal backup process postpones the temporal backup and iteratively rechecks for system shutdown and the system usage levels until the critical temporal backup time interval elapses, i.e., TIME≧(t+xi). Then, a forced temporal backup is invoked, regardless of the system usage level, the primary drive is scanned for files on the backup list that have been modified after the most recent temporal backup and then those files are backed up to the temporal backup device (step 440). The process then checks for shut-down condition (step 442) and reverts to step 410 where the amount of free memory is determined, tests the free memory amount for a critically low condition (step 412), and returns to iterative process beginning at step 416 for determining when to identify which temporally modified files to backup and backing up the identified files.

Returning again to step 428, if TIME≧(t+xi), a forced temporal backup will be invoked, regardless of the system usage. The primary drive is scanned for files on the backup list that have been modified after the most recent temporal backup and then those files are backed up to the temporal backup device (step 440). Following the forced temporal backup, the process once again checks for shut down condition (step 442) and ascertains the free memory amount (step 410), tests the free memory amount against the critically low condition (step 412), and returns to iterative process beginning at step 416 for determining when to identify which temporally modified files to backup and backing up the identified files. At some point, the system is shut down, and the temporal backup process ends.

As mentioned elsewhere above, the amount of memory space in the temporal backup device is relatively slight compared to that available in the primary hard drive, but very little memory is necessary for backing temporally modified files using the temporal backup process described immediately above. However, under certain circumstance the amount of free memory in the temporal backup device may reach a critically low level. This may be due to a particularly active user session, modifying many smaller files or modifying a few larger files that fill the temporal backup memory. Backing up email, with their associated attachments, and Internet temporary files will also lower the efficiency of the temporal backup process by filling the backup memory before a successful archival backup (where the stale files in the temporal backup can be deleted).

FIG. 5 is a flowchart depicting a hierarchical process for freeing temporal memory space in response to receiving a memory warning in accordance with an exemplary embodiment of the present invention. The memory freeing process is triggered with the user receiving a memory warning, as from step 414 above (step 502). If available, the entire content of the temporal backup memory automatically archived and the archival date/time reset (step 504), in which case the memory freeing process immediately ends. Archiving the contents of the temporal memory is performed automatically without the user's intervention, in which case the memory warning would be issued only in the contingency that the backup archive failed. Assuming an automated archival backup is not available, or fails, the memory freeing process proceeds in hierarchical memory freeing steps. Although the temporal backup process discussed with regard to the flowchart of FIGS. 4A and 4B automatically identifies stale files in the temporal backup memory and deletes them, the higher level process disclosed in the flowchart of FIG. 3 did not detect stale files, nor free up memory space. Therefore, some stale files might be present in the temporal backup memory. The files are first listed for viewing, preferably sorted by modification date/time, or the date/time they were backed up to the temporal backup memory (step 506). All files with a date/time prior to the most recent archive date/time are then identified (step 508) and deleted (step 510). The free memory amount in the temporal backup device is then tested for a critically low condition (step 512) and if the condition fails, the process ends.

If the amount of free memory in the temporal backup device is still critical, the next step of the hierarchical process is to identify files in the temporal backup device for archival backup (step 514). Any files that can be archived are copied to the archive memory (step 516) and the duplicative instances in the temporal backup device are deleted (step 518). However, it is not always possible for the user to archive files from the temporal backup device, either due to time constraints on the user or the unavailability of a reliable archive. In any case, the temporal backup memory is checked for free memory over the critically low amount (step 520) and if enough free memory is available, the process ends.

It is, however, possible that not enough stale files are present in the temporal backup and archiving temporal backup files does not cure the critical free memory condition. In that case, the user should identify any less important or out of date files in the temporal backup memory (step 522) and delete them. Because the memory space is critical, the user must delete some files in the temporal backup memory or risk that more important files from the primary drive will not backed up. It is probably the better choice for the user to select which files are not to be backed up in the temporal backup memory then risking an important file being lost as a result of a hard drive failure.

At some point a user may experience a hard drive failure while using the hard drive with an integrated mass storage file backup of the presently described invention. If that situation occurs, restoring the hard drive with system and data files is much simplified over the prior art restoration processes because only a negligible amount of important data is lost. The most recently modified files have been backed up to the temporal backup device and are readily available for restoration. Furthermore, the temporal backup memory also contains a current, and often very comprehensive, boot image from which to reboot and restore the system with a new drive, or from which a boot disk may be created for the initial system boot-up. What's more, often hard drive failures result from a logical failure which corrupts system operating files in the system partition of the primary drive that affects the operation of the drive. Because the temporal backup device has a current copy of many of the system files, it may be possible to reboot the system using the temporal backup drive and then immediately archive the important files from the primary drive, thus creating a complete and current image from which to mount on a replacement drive.

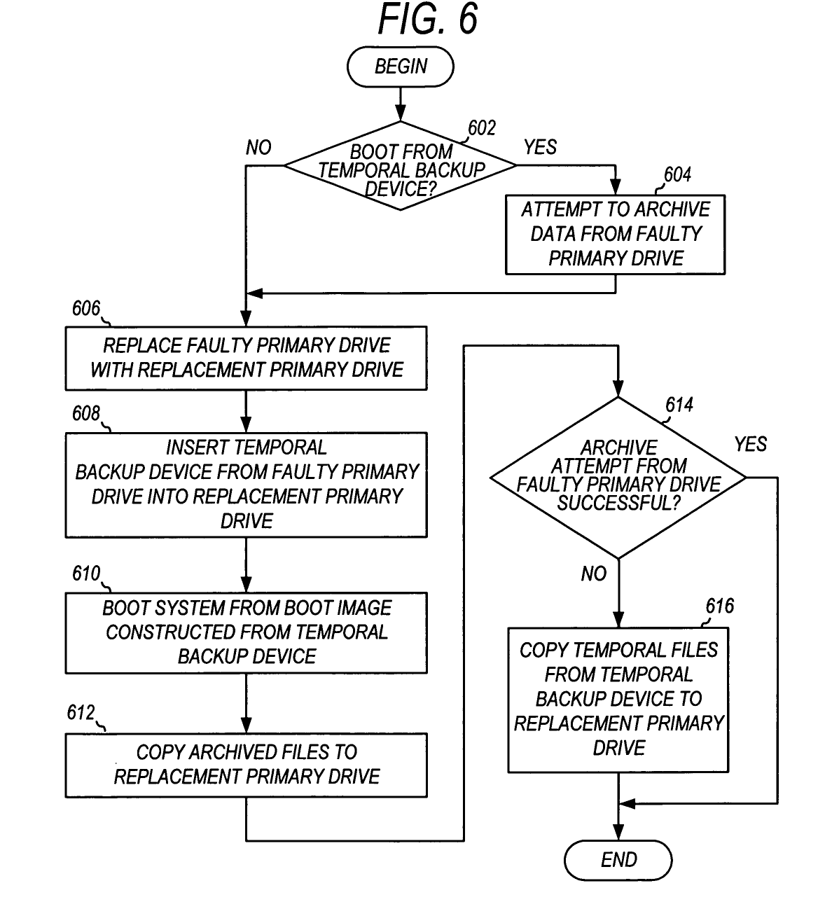

FIG. 6 is a flowchart depicting a process for restoring a faulty drive using hard drive with an integrated mass storage file backup in accordance with an exemplary embodiment of the present invention. The restoration process begins with a drive failure. Even though the primary drive may appear to be inoperable, the fault may be a logic error and/or corrupt system operating date on the primary drive. Therefore, before replacing the primary drive, the system is booted from the temporal backup device (step 602). If the boot is successful, the user attempts to archive an image of the faulty drive (step 640). Whether or not the archive is successful, the faulty primary drive assembly is substituted with a formatted replacement drive assembly (step 606). It is assumed that the system will be booted directly from the temporal backup drive when the temporal backup memory is installed in the replacement drive assembly. If that is not possible due to the interface type of the temporal backup device in the replacement drive, a boot disk is created from the backup memory on another machine prior to the memory being installed in the temporal backup device of the replacement primary drive assembly. The backup memory from the temporal backup device is then installed into the temporal backup device of the replacement primary drive assembly (step 608). As mentioned above, the temporal backup memory may be any one of a plurality of removable flash and micro drive memories that are commercially available.

Next, the system is booted from the temporal backup drive, or if booting directly from the temporal backup drive is not possible, from a boot disk created from a boot image on temporal backup memory. Finally, an archived image is restored to the replacement primary drive (step 612). If, at step 604, a final archival backup was successful (step 614), the restoration process ends. If not, the important temporal backup files from the temporal backup device are then restored to the replacement primary drive (step 616), the restoration process ends.

The hardware is a combination of a hard drive of any size and a removable mass storage device (for the purposes of this disclosure I will use micro drive since it can hold larger amounts of data. Flash cards, or similar removable storage devices could be used, they would be smaller and less expensive but still acceptable). This integration of the micro drive with hard drive provides the opportunity for instant back up for specific data submitted to the hard drive. The micro drive will have the sole purpose of housing backup for the hard drive it is integrated with, and should not be open to the user except through the provided software. The micro drive will not be physically exposed to the user (except inside the case), thus not allowing them to use the micro drive to swap files from one computer to another. Upon catastrophic failure of the hard drive the user can remove the broken hard drive and then remove the micro drive and copy the files to another computer or be connected to a new hard drive.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for backing up temporal data in a computer system, comprising;
receiving a data property, said data property designates data stored in a primary memory of the computer system for temporal backup;
receiving a temporal backup time period, said temporal backup time period defines a minimum time between successive temporal backups;
identifying a temporal backup memory for storing temporal data, said temporal backup memory is physically separate from the primary memory of the computer system and removably coupled to a primary drive assembly with the primary memory; and
performing a temporal back up, comprising:
detecting a time interval equivalent to the temporal backup time period;
identifying data in the primary memory with the data property; and
copying the identified data to the temporal backup memory.

2. The method for backing up temporal data recited in claim 1, wherein the data property is one of a file extension, filename and author username.

3. The method for backing up temporal data recited in claim 1, wherein the data property comprises a directory identifier of a current directory in the primary memory.

4. The method for backing up temporal data recited in claim 1, further comprising:
receiving a minimum free memory amount;
comparing free memory space in the temporal backup memory with the minimum free memory amount; and
deleting data in the temporal backup memory based on a deletion parameter.

5. The method for backing up temporal data recited in claim 4, wherein the deletion parameter is a data modification time for data modified on the temporal backup memory.

6. The method for backing up temporal data recited in claim 1, wherein the temporal backup time period is less than an archival backup time period, said archival backup time period is a minimum time interval between successive archival backup times to an archival memory.

7. The method for backing up temporal data recited in claim 6, further comprising:
comparing the identified data to archived data that exists in the archival memory;
selecting identified data that exists as archived data in the archival memory; and
excluding the selected identified data from the identified data.

8. The method for backing up temporal data recited in claim 7, further comprising:
receiving a minimum free memory amount;
comparing free memory space on the temporal backup memory with the free memory minimum amount; and
deleting data in temporal backup memory based on a value of deletion parameter

9. The method for backing up temporal data recited in claim 8, wherein the deletion parameter is a data modification indicator, and the value is a time prior to a recent archival backup time.

10. The method for backing up temporal data recited in claim 1, further comprising:
receiving a system usage parameter and maximum usage parameter level for the system parameter;
measuring current system usage level for the system usage parameter;
comparing the current system usage level to the maximum usage parameter level; and
rescheduling one of identifying data in the primary memory with the data property and copying the identified data to the temporal backup memory.

11. The method for backing up temporal data recited in claim 10, wherein performing a temporal backing up further comprises:
receiving a critical temporal time period;
measuring a second time interval, said second time being equivalent to the critical temporal time period; and
suspending all of measuring current system usage level for the system usage parameter, comparing the current system usage level to the maximum usage parameter level, and rescheduling one of identifying data in the primary memory with the data property and copying the identified data to the temporal backup memory.

12. The method for backing up temporal data recited in claim 1, further comprising:
removing the temporal backup memory for the primary drive assembly; and
coupling a substitute temporal backup memory to the primary drive assembly.

13. A system for backing up temporal data comprising:
a system bus;
a hard drive assembly comprising:
a primary hard drive to store data, executable code and temporal backup information, said temporal backup information comprises a data property for designating data in the primary hard drive for temporal backup, a temporal time period defining a minimum time interval between successive temporal backups and an identity of memory device for storing temporal data;
first electronics to operate and control the primary hard drive;
a first data connection coupled between the system bus and the first electronics;
a removable memory media to store temporal data from the primary hard drive;
second electronics to operate and control the removable memory media; and
a second data connection coupled between the system bus and the second electronics; and
a processor coupled to the system bus to measure a time interval equivalent to a temporal time period, and to instruct the first electronics to identify data in the primary memory with a data property and to copy the identified data to the temporal backup memory, from the primary hard drive to the removable memory media over the system bus.

14. The system recited in claim 13, wherein the hard drive assembly further comprises:
an assembly frame for supporting the primary hard drive and the first electronics, the assembly frame further comprises:
a compartment for housing the removable memory media; and
a cover for cooperating with the compartment and encasing the removable memory media.

15. The device recited in claim 13, wherein the removable memory media is one of a removable flash memory and a removable micro drive.

16. A computer program product comprising a computer usable medium having computer usable program code for backing up temporal data, said computer program product comprising:
computer usable program code for receiving a data property, said data property designates data for temporal backup from a primary memory of the computer system;
computer usable program code for receiving a temporal time period, said temporal time period defines a minimum time interval between successive temporal backups;
computer usable program code for receiving a minimum free memory minimum amount;
computer usable program code for identifying a temporal backup memory; and
computer usable program code for performing a temporal back up, comprising:
computer usable program code for measuring a time interval equivalent to a temporal time period;
computer usable program code for identifying data in the primary memory with the data property;
computer usable program code for copying the identified data to the temporal backup memory;
computer usable program code for comparing free memory space on the temporal backup memory with the minimum free memory amount; and
computer usable program code for deleting data in the temporal backup memory based on a deletion parameter.

17. The computer program product recited in claim 16, wherein the data property is one of a file extension, file name, author usemame.

18. The computer product recited in claim 16, wherein the data property comprises a directory identifier for a current directory in the primary memory.

19. The computer program product recited in claim 16, wherein the deletion parameter is a data modification time on the temporal backup memory.

20. The computer program product recited in claim 19, further comprising:
computer usable program code for receving a system usage parameter and maximum usage parameter level for the system parameter;
computer usable program code for measuring current system usage level for the system usage parameter;
computer usable program code for comparing the current system usage level to the maximum usage parameter level; and
computer usable program code for rescheduling one of identifying data in the primary memory with the data property and copying the identified data to the temporal backup memory.
